(19) United States
(12) Patent Application Publication
(10) Pub. No.: US 2022/0332243 A1
(43) Pub. Date: Oct. 20, 2022

(54) School Bus Stop Arm with Integrated Camera System

(71) Applicants: Karen DeVona McGirt, Charlotte, NC (US); Redell McGirt, JR., Charlotte, NC (US)

(72) Inventors: Karen DeVona McGirt, Charlotte, NC (US); Redell McGirt, JR., Charlotte, NC (US)

(21) Appl. No.: 17/669,264

(22) Filed: Feb. 10, 2022

Related U.S. Application Data
(60) Provisional application No. 63/177,130, filed on Apr. 20, 2021.

(51) Int. Cl. B60Q 1/26; B60Q 1/50; B60R 1/00; B60R 1/25; B60R 11/04; B60R 21/34; H04N 5/225

(52) U.S. Cl. CPC B60Q 1/2657; B60Q 1/50; B60R 1/002; B60R 1/25; B60R 11/04; B60R 21/34; H04N 5/2252; B60R 2011/004

(57) ABSTRACT

A school bus stop arm with integrated camera system includes a mounting box, an arm-actuating assembly, a stop sign, and a video camera unit. The arm-actuating assembly includes an actuating mechanism, an activation switch, and an elongated arm. The actuating mechanism is mounted within the mounting box so that the elongated arm can moved between a folded position and extended position. A proximal end of the elongated arm is mounted to the actuating mechanism. The stop sign is adjacently mounted to a distal end of the elongated arm. The video camera unit is mounted to the stop sign. The activation switch is operatively coupled with the elongated arm, wherein the activation switch selectively turns the video camera unit on or off based on the positioning of the elongated arm.

The current application claims a priority to the U.S. Provisional Patent application Ser. No. 63/177,130 filed on Apr. 20, 2021.

### FIELD OF THE INVENTION

The present invention relates generally to a school bus stop arm. More specifically, the present invention is a school bus stop arm with an integrated camera system to ensure traffic violations do not go unnoticed.

### BACKGROUND OF THE INVENTION

School Bus laws vary on a state-by-state basis. In most of these states it is illegal for a driver to pass a child carrying bus while it is stopped, whether the vehicles are on the same side of the road or the opposite side of an undivided roadway. Unfortunately, many motorists either do not know the laws or choose to disobey these road laws specifically designed to keep children safe from passing traffic. An estimated 50,000 motorists illegally pass school busses every single day which brings worry to the safety of the children in and around the school bus. In an attempt to bring attention to this matter, stop signs equipped one side of school buses are designed with flashing red lights and/or reflective signs so that the motorists can be warned when approaching a school bus. Unfortunately, with this method many motorists may not see the stop sign because the stop sign and lights do not bring enough attention. Additionally, many people may choose not to stop at a school bus stop sign due to lack of law enforcement present.

An objective of the present invention is to provide users with a school bus stop sign that helps track and report traffic law violations with an integrated camera system. In order to accomplish this, a preferred embodiment of the present invention comprises a school bus stop sign and a camera system that can record traffic violations. As a result, recorded data can be later utilized by law enforcement to ensure that the violators pay the correct fine for their traffic violation, which in turns improves the safety of the children.

### SUMMARY OF THE INVENTION

The present invention is a school bus stop sign to help monitor motorists from illegally passing school buses. The present invention seeks to provide users with a camera system that can record and track violators of school bus stop signs and report their information to the law enforcement. The camera system is integrated into the school bus stop arm and activated when the stop sign arm is fully extended. The present invention is able to record and store any traffic violations within an internal storage unit so that the law enforcement can access the recording to issue proper fines and traffic violations.

### BRIEF DESCRIPTION OF THE DRAWINGS

FIG. 1 is a front perspective view of the present invention, showing the activated position.

FIG. 2 is a rear perspective view of the present invention, showing the activated position.

FIG. 3 is a side view of the present invention, showing the activated position.

FIG. 4 is an exploded view of the mounting box of the present invention.

FIG. 5 is a schematic diagram showing the electrical connections to the hardwired vehicular power connector of the present invention.

FIG. 6 is a schematic diagram showing the electronical connections to the chipset of the present invention.

FIG. 7 is a top view of the present invention, showing the activated position.

FIG. 8 is a top view of the present invention, showing the deactivated position.

### DETAIL DESCRIPTIONS OF THE INVENTION

All illustrations of the drawings are for the purpose of describing selected versions of the present invention and are not intended to limit the scope of the present invention.

The present invention is a school bus stop arm with integrated camera system to capture and record traffic violators, The present invention also functions as a deterrent for motorists to minimize the number of traffic violations. The present invention enables law enforcement agents to identify potential traffic violators so they can be disciplined according to the rules of traffic laws.

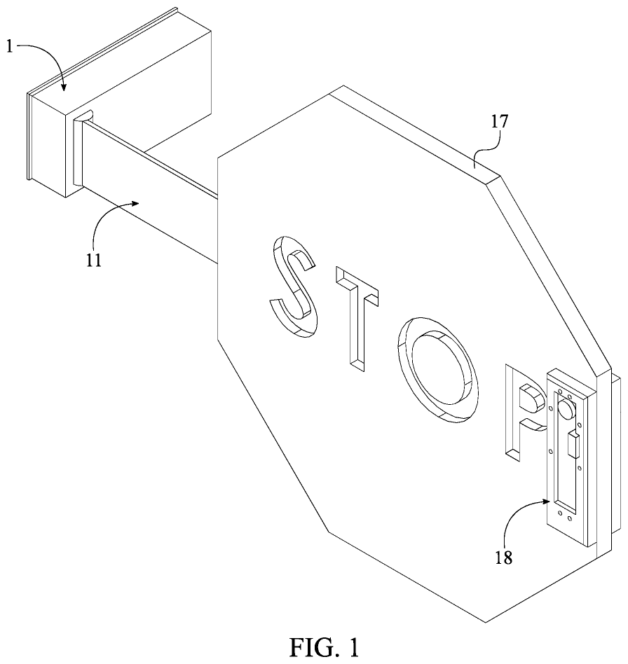

As shown in FIG. 1-3, the present invention comprises a mounting box 1, an arm-actuating assembly 11, a stop sign 17, and a video camera unit 18. The arm-actuating assembly 11 that allows the stop sign 17 to be positioned parallel to a driver side of the school bus or oriented towards road traffic comprises an actuating mechanism 12, an activation switch 13, and an elongated arm 14. In reference to general configuration of the present invention, the actuating mechanism 12 is mounted within the mounting box 1 so that the elongated arm 14 can be positioned in between a folded position and an extended position. A proximal end 15 of the elongated arm 14 is mounted to the actuating mechanism 12 as the stop sign 17 is adjacently mounted to a distal end 16 of the elongated arm 14. When the elongated arm 14 is at the folded position via the actuating mechanism 12, the stop sign 17 is positioned parallel to the driver side of the school bus. When the elongated arm 14 is at the extended position via the actuating mechanism 12, the stop sign 17 is oriented towards road traffic and perpendicularly positioned to the driver side of the school bus. The video camera unit 18 is mounted to the stop sign 17 so that the video camera is able to record the front end and the rear end of the driver side of the school bus. The activation switch 13 is operatively coupled with the elongated arm 14, wherein the activation switch 13 selectively turn-on and turn-off the video camera unit 18 upon the positioning of the elongated arm 14. More specifically, the video camera unit 18 is configured between an activated position and a deactivated position with respect to the positioning of the elongated arm 14.

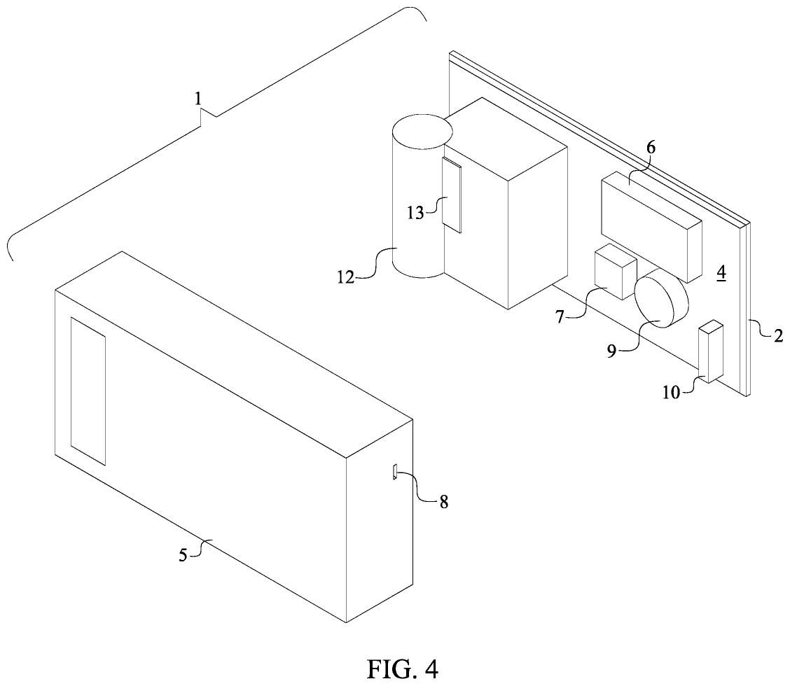

The mounting box 1 functions as the base structure of the present invention as the present invention is mounted to the driver side of the school bus via the mounting box 1. In reference to FIG. 4, the mounting box 1 comprises a base plate 2, a cover 5, a chipset 6, a wireless module 7, at least one universal serial bus (USB) port 8, a data storage device 9, and a hardwired vehicular power connector 10. The base plate 2 function as a platform so that the mounting box 1 can be secured to the school bus. More specifically, the base plate 2 comprises a school bus mounting surface 3 and an exterior surface 4, wherein the school bus mounting surface 3 is oppositely positioned of the exterior surface 4. When the base plate 2 is mounted to the school bus, the school bus mounting surface 3 is positioned adjacent to the school bus, and the exterior surface 4 is oriented away from the school bus. The chipset 6 that performs and executes data flow management within the present invention is connected onto the exterior surface 4 of the base plate 2. The wireless module 7 is connected onto the exterior surface 4 of the base plate 2 and functions as a local area network so that the present invention can be remotely communicated with a mobile network. The data storage device 9 is connected onto the exterior surface 4 of the base plate 2 so that the present invention is able to store video files from the video camera unit 18 and any other type of files. The USB port 8 is integrated into the cover 5 so that an external storage devices can transfer digital data from the data storage device 9 when necessary. The hardwired vehicular power connector 10 is connected onto the exterior surface 4 of the base plate 2 and functions as the power connector 10 of the present invention. The cover 5 is perimetrically mounted to the base plate 2 and functions as an enclosure for the components that are mounted to the base plate 2. As a result, the chipset 6, the wireless module 7, the data storage device 9, and the hardwired vehicular power connector 10 are enclosed within the base plate 2 and the cover 5 thus protecting them from outside elements.

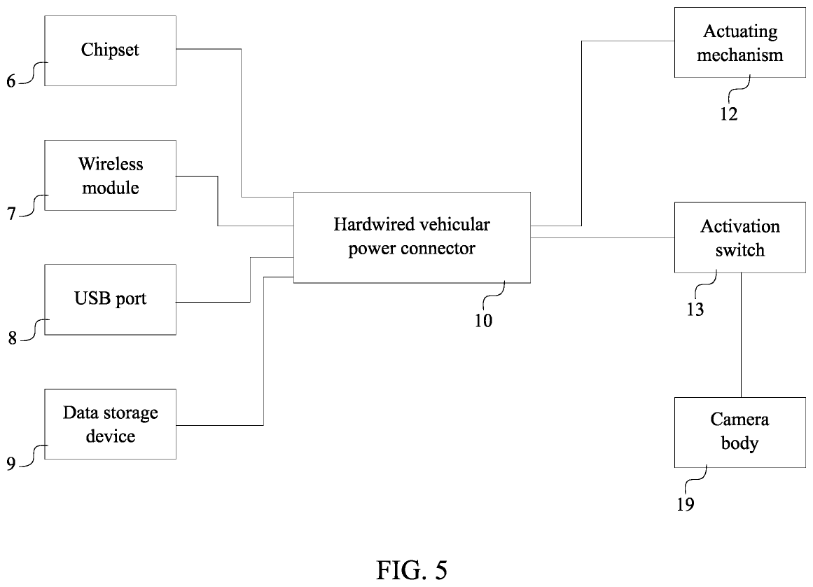

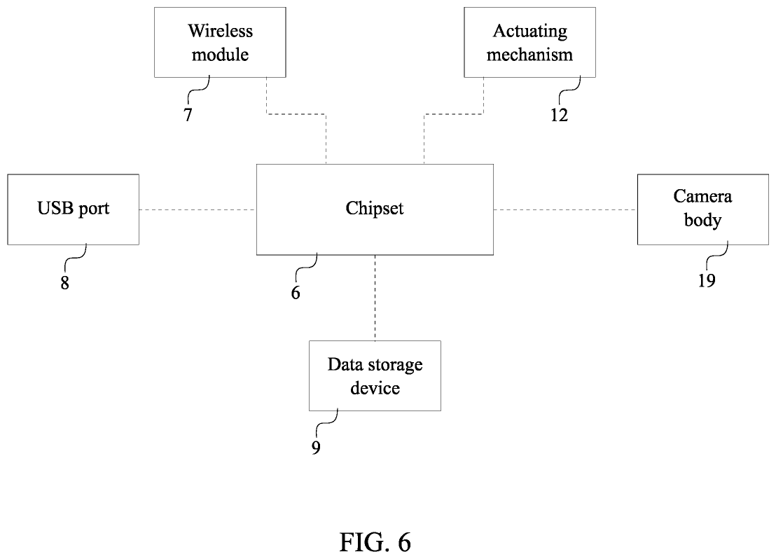

In reference to FIG. 5, the chipset 6, the wireless module 7, the USB port 8, the data storage device 9 are electrically connected to the hardwired vehicular power connector 10 to electrically power each of the aforementioned components. In reference to FIG. 6, the wireless module 7, the USB port 8, and the data storage device 9 are electronically connected to the chipset 6 thus allowing data transmission between each of the aforementioned components for optimal operation of the present invention.

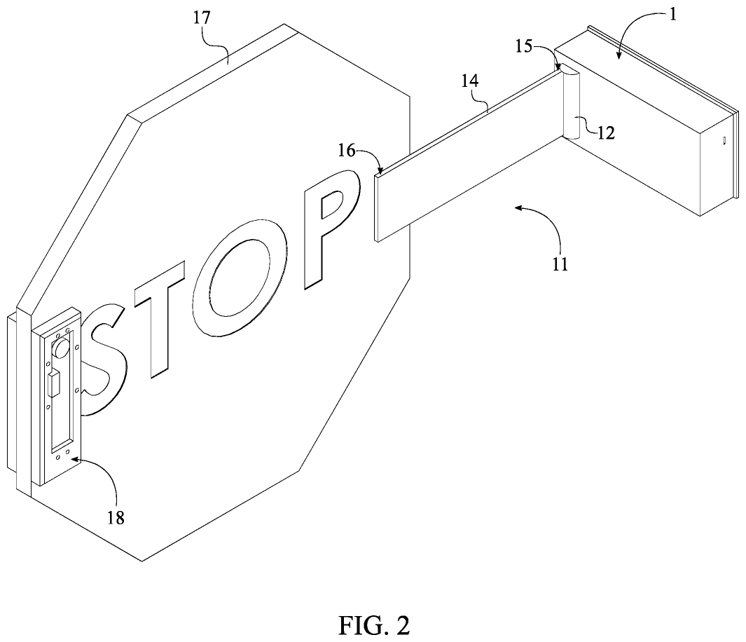

In reference to FIG. 1-2, the stop sign 17 is made of a thin metal material with a red octagonal shape. The stop sign 17 has large white lettering that spells out “STOP” on the front side and back side of the stop sign 17 to match the universally known sign for a motor vehicle to stop when approaching. As a result, when the elongated arm 14 displays the stop sign 17 to the approaching motorists of the school bus, motorists can stop their vehicles according to the prevailing traffic laws.

In reference to FIGS. 2 and 4, the actuating mechanism 12 is mounted onto the exterior surface 4 of the base plate 2 so that the elongated arm 14 can be moved in between the extended position and the folded position. The actuating mechanism 12 can be a vacuum system, an electrical system, pneumatic system, or any other type of industry standard mechanism that enables the movement of the elongated arm 14. The activation switch 13 is mounted adjacent to the actuating mechanism 12 to selectively power the video camera unit 18. For example, depending upon different embodiment of the present invention, the activation switch 13 can be mounted the base plate 2 or the proximal end 15 of the elongated arm 14 as the functionality of the activation switch 13 remains consistent. As shown in FIG. 5, the actuating mechanism 12 and the activation switch 13 are electrically connected to the hardwired vehicular power connector 10 so that the actuating mechanism 12 and the activation switch 13 can be electrically powered. As shown in FIG. 6, the actuating mechanism 12 is electronically connected to the chipset 6 so that the chip set 6 is able to determine the positioning of the elongated arm 14. Furthermore, the actuating mechanism 12 and the activation switch 13 are enclosed within the base plate 2 and the cover 5 to protect mechanical components and electrical components from outside elements.

In reference to FIG. 5, the hardwired vehicular power connector 10 is electrically connected to the vehicular battery so that the chipset 6, the wireless module 7, the USB port 8, the data storage device 9, the actuating mechanism 12, and the activation switch 13 can be directly powered. The hardwired vehicular power connector 10 pulls electrical current directly from the vehicular battery so that a steady stream of electrical current can be supplied to the chipset 6, the wireless module 7, the USB port 8, the data storage device 9, the actuating mechanism 12, and the activation switch 13. Preferably, the hardwired vehicular power connector 10 is routed through the vehicular electrical fuse box to prevent continuous battery drainage. In other words, the hardwired vehicular power connector 10 only pulls electrical power from the vehicular battery when the ignition switch is at the on-position. If necessary, the hardwired vehicular power connector 10 can also be configured into a direct electrical connection wherein the chipset 6, the wireless module 7, the USB port 8, the data storage device 9, the actuating mechanism 12, and the activation switch 13 are continuously powered regardless of the status of the ignition switch.

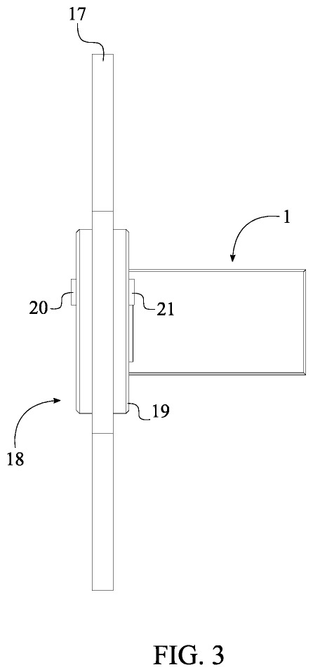

In reference to FIG. 3, the video camera unit 18 comprising a camera body 19, a front lens 20, and a rear lens 21. The camera body 19 is mounted within the stop sign 17 as the camera body 19 and the stop sign 17 are centrally positioned of each other. The camera body 19 comprises a housing and a plurality of electronic components that enable the operation of the video camera unit 18 similar to existing video cameras, wherein the plurality of electronic components is mounted within the housing. The front lens 20 is integrated onto the camera body 19 so that the front lens 20 is able to visually cover 5 the front end of the driver side of the school bus. The rear lens 21 is integrated onto the camera body 19 and position opposite of the front lens 20 so that the rear lens 21 is able to visually cover 5 the rear end of the driver side of the school bus. In order to power the video camera unit 18, the camera body 19 is electrically connected to the activation switch 13. The camera body 19 is also electronically connected to the chipset 6 so that the generated video files of the camera body 19 can be transmitted into the data storage device 9 via the chipset 6.

Optionally, the present invention may comprise a doppler radar unit to further identify passing motorist when the school bus stop arm is deployed. When a doppler radar unit is utilized within the present invention, the doppler radar unit is mounted to the camera body 19 and electrically connected to the activation switch 13 and electronically connected to the chipset 6. As a result, the activation switch 13 able to selectively turn-on and turn-off the doppler radar unit with respect to the positioning of the elongated arm 14. Any velocity data generated by the doppler radar unit is then able to transmit into the chipset 6 due to the electronical connection between the doppler radar unit and the chipset 6.

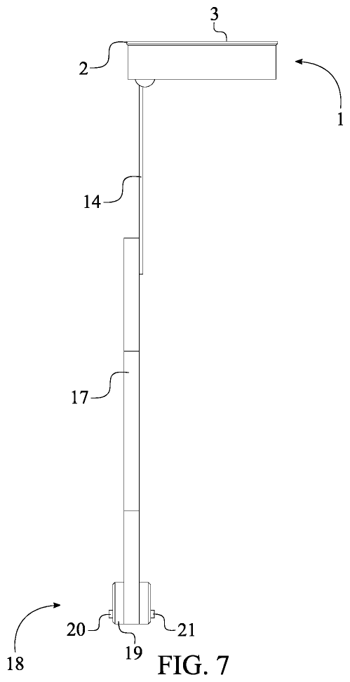

When the video camera unit 18 is configured into the activated position, the elongated arm 14 and the base plate 2 are positioned at a right angle wherein the elongated arm 14 maintains a stationary position as shown in FIG. 7. Due to the positioning of the elongated arm 14, the stop sign 17 is displayed to the motorists thus warning them to stop their vehicles. Simultaneously, the video camera unit 18 is activated by the activation switch 13 as the electrical power is supplied to the camera body 19 via the activation switch 13. Then the video camera unit 18 is able to start recording a designated field of view and transmitting video files into the data storage device 9.

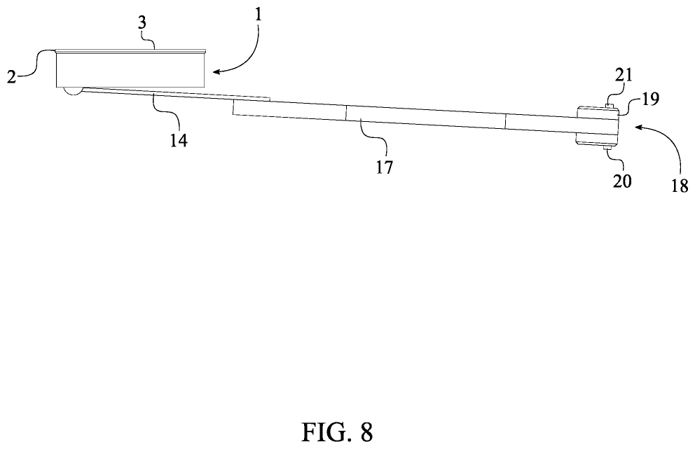

In reference to FIG. 8, when the video camera unit 18 is configured into the deactivated position, the elongated arm 14 and the base plate 2 are positioned at an acute angle thus deactivating the video camera unit 18 via the activation switch 13. For example, the video camera unit 18 maintains the deactivated position when the elongated arm 14 moves from the folded position to the extended position or when the elongated arm 14 moves from the extended position to the folded position. In other words, as soon as the actuating mechanism 12 initiate the movement of the elongated arm 14, the activation switch 13 disconnects the electrical power to the camera body 19. As a result, the video camera unit 18 stops recording the designated field of view and transmitting video files into the data storage device 9.

Once the video camera unit 18 has recorded a motorist passing the stop sign 17, and the corresponding recording is stored within the data storage device 9, the law enforcement agents can directly access the corresponding recording through the USB port 8 or wirelessly access the corresponding recording through the wireless module 7 and a user interface. Then the law enforcement agents can ensure that the violator is properly penalized. As a result, motorists are less likely to violate the traffic law in the future due to the new method of enforceability.

Although the invention has been explained in relation to its preferred embodiment, it is to be understood that many other possible modifications and variations can be made without departing from the spirit and scope of the invention as hereinafter claimed.

What is claimed is:

1. A school bus stop arm with integrated camera system comprising;
a mounting box;
an arm-actuating assembly;
a stop sign;
a video camera unit;
the arm-actuating assembly comprising an actuating mechanism, an activation switch, and an elongated arm;
the actuating mechanism being mounted within the mounting box;
a proximal end of the elongated arm being mounted to the actuating mechanism;
the stop sign being adjacently mounted to a distal end of the elongated arm;
the video camera unit being mounted to the stop sign; and
the activation switch being operatively coupled with the elongated arm, wherein the activation switch selectively turn-on and turn-off the video camera unit upon the positioning of the elongated arm.

2. The school bus stop arm with integrated camera system as claimed in claim 1 comprising;
the mounting box comprising a base plate, a cover, a chipset, a wireless module, at least one universal serial bus (USB) port, a data storage device, and a hardwired vehicular power connector;
the chipset being connected onto an exterior surface of the base plate;
the wireless module being connected onto the exterior surface of the base plate;
the USB port being integrated into the cover;
the data storage device being connected onto the exterior surface of the base plate;
the hardwired vehicular power connector being connected onto the exterior surface of the base plate;
the cover being perimetrically mounted to the base plate; and
the chipset, the wireless module, the data storage device, and the hardwired vehicular power connector being enclosed within the base plate and the cover.

3. The school bus stop arm with integrated camera system as claimed in claim 2 comprising;
the chipset, the wireless module, the USB port, the data storage device being electrically connected to the hardwired vehicular power connector; and
the wireless module, the USB port, and the data storage device being electronically connected to the chipset.

4. The school bus stop arm with integrated camera system as claimed in claim 2 comprising;
the base plate further comprising a school bus mounting surface; and
the school bus mounting surface being oppositely positioned of the exterior surface.

5. The school bus stop arm with integrated camera system as claimed in claim 1 comprising;
the mounting box comprising a base plate, a cover, a chipset, and a hardwired vehicular power connector;
the actuating mechanism being mounted onto the exterior surface of the base plate;
the activation switch being mounted adjacent to the actuating mechanism;
the actuating mechanism and the activation switch being enclosed within the base plate and the cover;
the actuating mechanism and the activation switch being electrically connected to the hardwired vehicular power connector; and
the actuating mechanism being electronically connected to the chipset.

6. The school bus stop arm with integrated camera system as claimed in claim 1 comprising;
the video camera unit comprising a camera body, a front lens, and a rear lens;
the camera body being mounted within the stop sign;
the camera body and the stop sign being centrally positioned of each other;
the front lens being integrated onto the camera body;
the rear lens being integrated onto the camera body, opposite of the front lens;
the camera body being electrically connected to the activation switch; and
the camera body being electronically connected to the chipset.

7. The school bus stop arm with integrated camera system as claimed in claim 1, wherein the video camera unit is configured between an activated position and a deactivated position.

8. The school bus stop arm with integrated camera system as claimed in claim 7 comprising;
the activated position;
the elongated arm and the base plate being positioned at a right angle; and
the video camera unit being activated by the activation switch.

9. The school bus stop arm with integrated camera system as claimed in claim 7 comprising;
the deactivated position;
the elongated arm and the base plate being positioned at an acute angle; and
the video camera unit being deactivated by the activation switch.

10. A school bus stop arm with integrated camera system comprising;
a mounting box;
an arm-actuating assembly;
a stop sign;
a video camera unit;
the arm-actuating assembly comprising an actuating mechanism, an activation switch, and an elongated arm;
the video camera unit comprising a camera body, a front lens, and a rear lens;
the actuating mechanism being mounted within the mounting box;
a proximal end of the elongated arm being mounted to the actuating mechanism;
the stop sign being adjacently mounted to a distal end of the elongated arm;
the video camera unit being mounted to the stop sign;
the camera body being mounted within the stop sign;
the camera body and the stop sign being centrally positioned of each other;
the front lens being integrated onto the camera body;
the rear lens being integrated onto the camera body, opposite of the front lens; and
the activation switch being operatively coupled with the elongated arm, wherein the activation switch selectively turn-on and turn-off the video camera unit upon the positioning of the elongated arm.

11. The school bus stop arm with integrated camera system as claimed in claim 10 comprising;
the mounting box comprising a base plate, a cover, a chipset, a wireless module, at least one universal serial bus (USB) port, a data storage device, and a hardwired vehicular power connector;
the chipset being connected onto an exterior surface of the base plate;
the wireless module being connected onto the exterior surface of the base plate;
the USB port being integrated into the cover;
the data storage device being connected onto the exterior surface of the base plate;
the hardwired vehicular power connector being connected onto the exterior surface of the base plate;
the cover being perimetrically mounted to the base plate; and
the chipset, the wireless module, the data storage device, and the hardwired vehicular power connector being enclosed within the base plate and the cover.

12. The school bus stop arm with integrated camera system as claimed in claim 11 comprising;
the chipset, the wireless module, the USB port, the data storage device being electrically connected to the hardwired vehicular power connector; and
the wireless module, the USB port, and the data storage device being electronically connected to the chipset.

13. The school bus stop arm with integrated camera system as claimed in claim 11 comprising;
the base plate further comprising a school bus mounting surface; and
the school bus mounting surface being oppositely positioned of the exterior surface.

14. The school bus stop arm with integrated camera system as claimed in claim 10 comprising;
the mounting box comprising a base plate, a cover, a chipset, and a hardwired vehicular power connector;
the actuating mechanism being mounted onto the exterior surface of the base plate;
the activation switch being mounted adjacent to the actuating mechanism;
the actuating mechanism and the activation switch being enclosed within the base plate and the cover;
the actuating mechanism and the activation switch being electrically connected to the hardwired vehicular power connector; and
the actuating mechanism being electronically connected to the chipset.

15. The school bus stop arm with integrated camera system as claimed in claim 10 comprising;
the camera body being electrically connected to the activation switch; and
the camera body being electronically connected to the chipset.

16. The school bus stop arm with integrated camera system as claimed in claim 10, wherein the video camera unit is configured between an activated position and a deactivated position.

17. The school bus stop arm with integrated camera system as claimed in claim 16 comprising;
the activated position;
the elongated arm and the base plate being positioned at a right angle; and
the video camera unit being activated by the activation switch.

18. The school bus stop arm with integrated camera system as claimed in claim 16 comprising;
the deactivated position;
the elongated arm and the base plate being positioned at an acute angle; and
the video camera unit being deactivated by the activation switch.
